(19) United States
(12) Patent Application Publication
(10) Pub. No.: US 2026/0170030 A1
(43) Pub. Date: Jun. 18, 2026

(54) METHOD AND DEVICE WITH AUTOMATICAL RESPONSE GENERATION

(71) Applicant: Samsung Electronics Co., Ltd., Suwon-si (KR)

(72) Inventors: Eunhee KANG, Suwon-si (KR); Sehwan KI, Suwon-si (KR); Sun Ho KIM, Suwon-si (KR); Myungsub CHOI, Suwon-si (KR); Hyong Euk LEE, Suwon-si (KR)

(73) Assignee: Samsung Electronics Co., Ltd., Suwon-si (KR)

(21) Appl. No.: 19/231,802

(22) Filed: Jun. 9, 2025

(30) Foreign Application Priority Data
Dec. 17, 2024 (KR) 10-2024-0188285

(51) Int. Cl. G06F 16/334; G06F 16/35

(52) U.S. Cl. CPC G06F 16/334; G06F 16/35

(57) ABSTRACT

Disclosed is a method of automatically generating a response to an information request (IR) and a device thereof. The method includes classifying at least one item included in an IR for each of target sections in a standardized document format, generating a sub-IR corresponding to each of the target sections, generating a sub-response responding to the sub-IR for each of the target sections by performing first reasoning of a neural network model based on a retrieval result related to the target sections and the sub-IR, and generating a response to the IR by performing second reasoning of the neural network model based on the sub-response generated for each of the target sections.

### CROSS-REFERENCE TO RELATED APPLICATIONS

This application claims the benefit under 35 USC § 119(a) of Korean Patent Application No. 10-2024-0188285, filed on Dec. 17, 2024, in the Korean Intellectual Property Office, the entire disclosure of which is incorporated herein by reference for all purposes.

### BACKGROUND

### 1. Field

The following description relates to a method and device with automatic response generation.

### 2. Description of Related Art

An approval process for a new and/or generic drug may typically start with preparation and submission of a Common Technical Document (CTD) to the regulatory authorities in each country. The CTD may be written based on the results of all experiments conducted during drug development, including nonclinical and clinical trials. When the CTD is submitted to a regulatory agency such as the U.S. Food and Drug Administration (FDA) or the Ministry of Food and Drug Safety (MFDS) in South Korea, the approval process may proceed by an iterative cycle in which the agency issues an information request (IR) seeking supplementation of any insufficient items and the applicant responds accordingly.

Throughout this iterative process, researchers need to frequently consult numerous experimental documents in order to draft and submit extensive responses to the IRs. This repetitive and labor-intensive task can significantly reduce the overall efficiency of the drug approval process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes classifying at least one item included in an information request (IR) for each of target sections in a standardized document format; generating a sub-IR corresponding to each of the target sections; for the sub-IR, generating a sub-response by performing first reasoning of a neural network model based on a retrieval result related to the target sections and the sub-IR; and generating a final response to the IR by performing second reasoning of the neural network model based on the sub-response.

The generating of the sub-IR may include classifying the at least one item for each of the target sections by analyzing the IR; determining whether to perform supplementation for the at least one item based on the target sections; retrieving a similar case corresponding to the target sections by searching a relevant database (DB) in response to a determination that the supplementation is required; and generating the sub-IR based on the similar case.

The determining of whether to perform the supplementation may include determining whether the at least one item is a simple error or requires an additional response.

The retrieving of the similar case may include retrieving, from the relevant DB storing an approved document of previously approved products, the similar case comprising a target IR corresponding to a section same as the at least one item and a response matching to the target IR by a summary corresponding to the at least one item.

The generating of the sub-response may include retrieving, from the DB, a source document and a standard document for a response to the sub-IR; determining whether a response for the sub-response is able to be generated from the source document and the standard document; and in response to a determination that the response is able to be generated, generating the sub-response by performing the first reasoning of the neural network model using any one or any combination of two or more of the source document, the standard document, the sub-IR, the similar case, a first score fed back according to previous reasoning of the neural network model, and a result of the previous reasoning corresponding to the target sections.

The retrieving of the source document and the standard document may include classifying first items of the source document for each of the target sections and extracting a first feature based on meaning of the classified first items corresponding to the target sections; classifying second items of the standard document for each of the target sections and extracting a second feature based on meaning of the classified second items corresponding to the target sections; encoding the sub-IR into a third feature; and retrieving the source document and the standard document according to whether the first feature and the second feature match the third feature.

The retrieving of the source document and the standard document may include using a table that matches to at least two of a class of the target sections, the sub-IR, and the IR.

The retrieving of the source document and the standard document may include extracting a keyword having a correlation between the sub-IR and the IR; and retrieving the source document and the standard document from the DB based on the keyword and a class of the target sections.

The determining of whether the response is able to be generated may include extracting one or more contexts matching to a response required by the sub-IR from the source document and the standard document; and determining whether the response is able to be generated by the extracted one or more contexts.

The extracting of the context may include adjusting a number of the extracted one or more contexts based on a responding difficulty level associated with the sub-IR.

The method may further include determining a first score corresponding to the response based on a similarity between the extracted one or more contexts and the response; and performing a first evaluation of the sub-response based on a comparison result of comparing the first score and a first threshold value.

The method may further include providing feedback of either one or both of the first score and a determination rationale corresponding to the first score to the neural network model, as a reference material for the first reasoning.

The method may further include, in response to determining that the response cannot be generated, determining whether additional experiment data is required, and generating an additional experiment request signal when the additional experiment data is required.

The generating of the final response may include collecting the sub-response generated for each of the target sections; determining whether the collected sub-response satisfies the IR; and outputting the final response when the collected sub-response satisfies the IR.

The method may further include, when the IR is not satisfied, generating a new sub-IR by classifying the at least one item for each of new target sections.

In one general aspect, provided is a non-transitory computer-readable storage medium storing instructions that, when executed by one or more processors, configure the one or more processors to perform the method described herein.

In one general aspect, an electronic device includes one or more processors configured to classify at least one item included in an information request (IR) for each of target sections in a standardized document format and generate a sub-IR corresponding to each of target sections; generate a sub-response to the sub-IR for each of the target sections by performing first reasoning of a neural network model based on a retrieval result related to the target sections and the sub-IR; and generate a response to the IR by performing second reasoning of the neural network model based on the sub-response generated for each of the target sections and output the response.

The one or more processors may be further configured to classify the at least one item for each of the target sections by analyzing the IR; determine whether to perform supplementation for the at least one item based on the target sections; retrieve a similar case corresponding to the target sections by searching a relevant database (DB) in response to a determination that the supplementation is required; and generate the sub-IR based on the similar case.

The one or more processors may be further configured to retrieve a source document and a standard document for a response to the sub-IR from the DB; determine whether a response for the sub-response is able to be generated by the source document and the standard document; and in response to a determination that the response is able to be generated, generate the sub-response by performing the first reasoning of the neural network model using any one or any combination of two or more of the source document, the standard document, the sub-IR, the similar case, a first score fed back according to previous reasoning of the neural network model, and a result of the previous reasoning corresponding to the target sections.

The one or more processors may be further configured to collect the sub-response generated for each of the target sections; determine whether the collected sub-response satisfies the IR; and generate the response in response to a determination that the collected sub-response satisfies the IR.

In one general aspect, a processor-implemented method includes retrieving a similar case from a database of approved documents, the similar case comprising a prior information request (IR) and corresponding response mapped to a target section matching a classified item among target sections of a standardized document; and generating a sub-IR for the target section based on the similar case; retrieving, from the database, source and standard documents relevant to the sub-IR; extracting one or more contexts from the retrieved documents, wherein a number of extracted contexts is dynamically adjusted based on a responding difficulty level of the sub-IR; generating a sub-response via first reasoning of a neural network model using the extracted contexts; evaluating the sub-response based on a similarity between the sub-response and the extracted contexts; and generating a final response to an IR by aggregating sub-responses including the sub-response, and performing second reasoning of the neural network model, wherein the second reasoning incorporates feedback from the similarity to refine the final response.

Other features and aspects will be apparent from the following detailed description, the drawings, and the claims.

### BRIEF DESCRIPTION OF THE DRAWINGS

FIG. 1 illustrates an example process of operating a neural network model according to one or more embodiments.

FIG. 2A illustrates an example process of an electronic device generating a sub-information request (IR) by a neural network model according to one or more embodiments.

FIG. 2B illustrates an example process of an electronic device generating a sub-response by a neural network model according to one or more embodiments.

FIG. 2C illustrates an example process of an electronic device generating a response by a neural network model according to one or more embodiments.

FIG. 3 illustrates an example operation of artificial intelligence (AI) agents to generate a sub-IR according to one or more embodiments.

FIG. 4 illustrates an example operation of AI agents to generate a sub-response according to one or more embodiments.

FIGS. 5A through 5C illustrates respective example method of retrieving a source document and a standard document using a database (DB) agent according to one or more embodiments.

FIG. 6 illustrates an example operation of AI agents to generate a response according to one or more embodiments.

FIG. 7 illustrates an example method of automatically generating a response according to one or more embodiments.

FIG. 8 illustrates an example method of generating a sub-IR according to one or more embodiments.

FIG. 9 illustrates an example method of generating a sub-response according to one or more embodiments.

FIG. 10 illustrates an example method of generating a response according to one or more embodiments.

FIG. 11 illustrates an example method of automatically generating a response responding to a query according to one or more embodiments.

FIG. 12 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

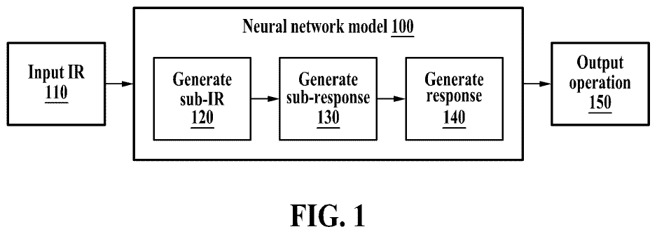

FIG. 1 illustrates an example process of operating a neural network model according to one or more embodiments. Referring to FIG. 1, when an information request (IR) 110 is input to an electronic device according to an example, the figure illustrates a process in which a response 140 corresponding to the IR 110 is generated via a neural network model 100, and an operation 150 in which the response 140 is output.

As described above, the IR 110 may be a document requesting supplementation of insufficient items in the Common Technical Document (CTD) submitted to the approval agency of each country, such as the U.S. Food and Drug Administration (FDA) or the Ministry of Food and Drug Safety of South Korea. The CTD is a standardized document format used for drug regulatory submissions and may include comprehensive information regarding safety, efficacy, and quality of new drugs. The CTD may be prepared based on experimental results obtained during the development of the new drugs, including nonclinical and/or clinical trials. The CTD may be divided into multiple sub-sections, such as Module 1 (M1 ) through Module 5 (M5 ). For example, Section M1 may include an application content and regional administrative requests. Section M2 may include an overview and summary of a material in the CTD. Section M3 may include an evaluation material for quality of drugs, such as a manufacturing process, ingredients, and quality management of new drugs. Section M4 may include a nonclinical research material such as animal testing data. Section M5 may include a clinical trial material involving human subjects. A pharmaceutical company or researcher may seek regulatory approval for a new drug and/or a generic drug by submitting the response 140 to the IR 110.

The electronic device of one or more embodiments may include an artificial intelligence (AI) agent system comprising a plurality of AI agents configured to draft the response 140 to the IR 110 during the approval process of a new drug and/or a generic drug. Each AI agent may perform one or more of various functions such as natural language processing (NLP), decision making, problem solving, and interacting with an external environment. The AI agents may be generated by training an AI model using collected data. The AI agents may understand a query and provide a suitable response using NLP technologies as a non-limiting example.

The electronic device may generate a plurality of sub-IRs 120, generate a sub-response 130 for each sub-IR 120, and ultimately generate the response 140 based on the IR 110 using the neural network model 100. The electronic device may output the response 140 via the output operation 150.

The process of generating the sub-IR 120 may proceed as follows.

Prior to generating the sub-IR 120, the electronic device may analyze the IR 110 to determine the context and rationale of a request. For example, the electronic device may identify a request background and/or a request rationale of the IR 110, and identify a section (“target section”) of at least one item for which supplementation (e.g., additional information and/or correction) is requested through the IR 110. The identified at least one item may correspond to, for example, a CTD section.

The electronic device may classify the at least one item into the respective target sections. The electronic device may decompose the contents of the IR 110 into the plurality of sub-IRs 120 for the respective target sections and then generate the sub-response 130 for each sub-IR 120 according to a predetermined response strategy.

The electronic device may determine relevance of the supplementation request included in the IR 110 for each of the target sections. The electronic device may determine whether the at least one item is a simple error or requires an additional response with reference to a relevant standard document (e.g., a CTD material) and/or a source document. When it is determined that the at least one item is a simple error, the electronic device may generate and submit a response in which the simple error is corrected.

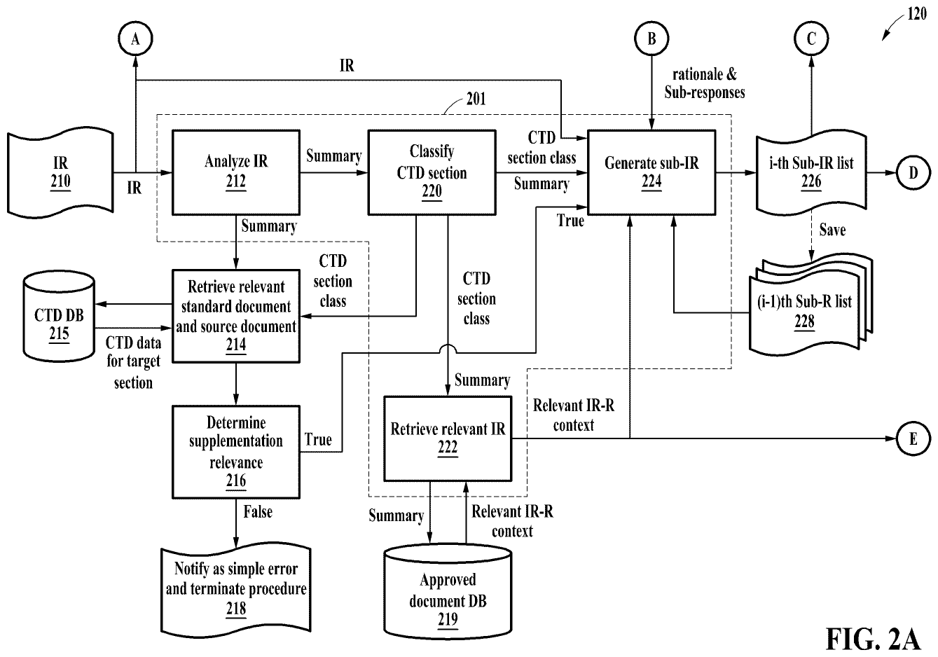

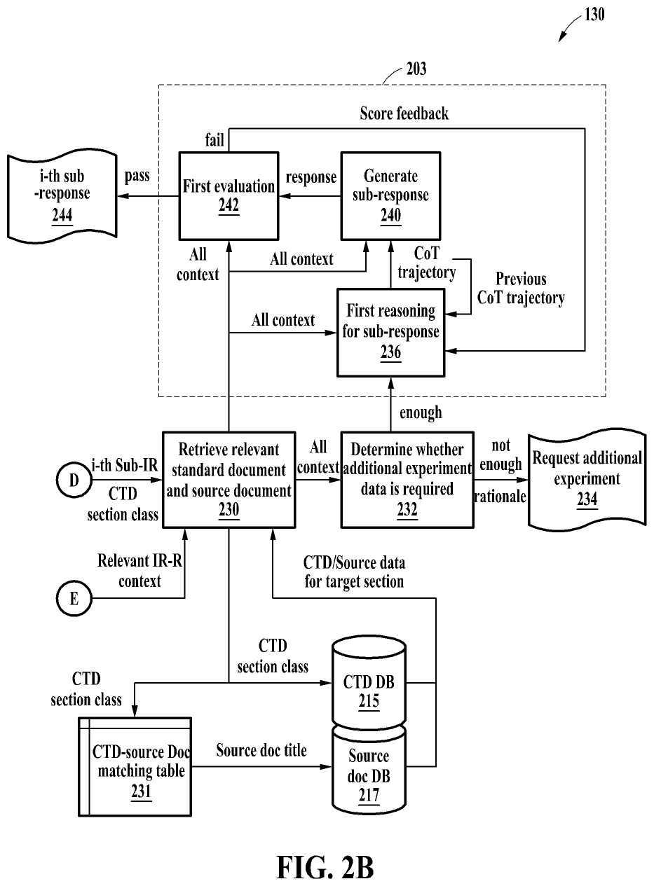

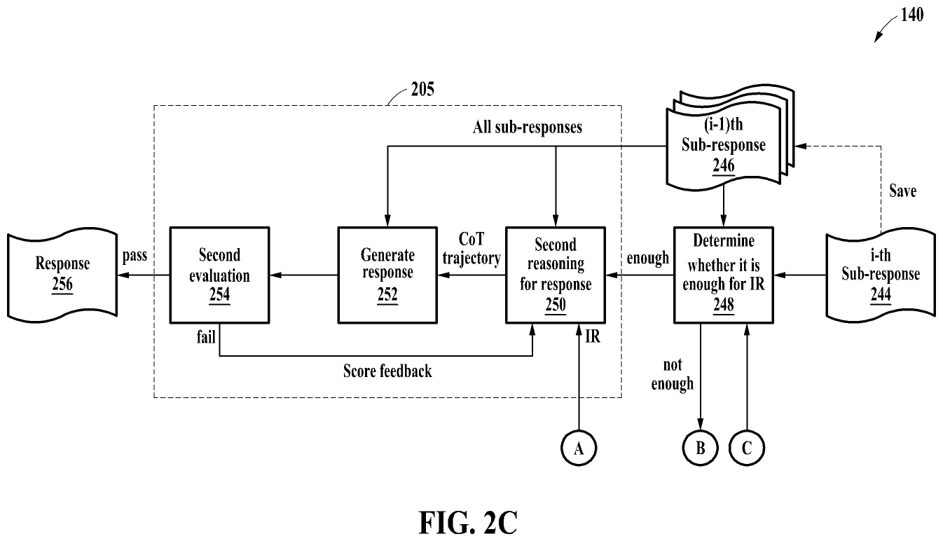

On the other hand, when it is determined that the additional response is required, the electronic device may search a relevant database (DB) (e.g., an approved document DB 219 of FIG. 2A) to retrieve a similar case corresponding to the target sections. The electronic device may retrieve a similar case that is similar to a corresponding IR (or at least one item included in a corresponding IR) among a previous project or a previous supplementation response. The electronic device may generate the sub-IR 120 based on the similar case. The process of generating the sub-IR 120 will be described in more detail with reference to FIG. 2A below.

The electronic device may generate the sub-response 130 to the sub-IR 120. For each of the target sections, the electronic device may perform first reasoning of the neural network model 100 based on a retrieval result related to the target sections and the sub-IR 120, thereby generating the sub-response 130.

The electronic device may generate each sub-response 130 by using the contents of the relevant standard document and/or source document. The electronic device may perform second reasoning of the neural network model 100 based on the sub-response 130 generated for each of the target sections, thereby generating the response 140. The electronic device may generate the response 140 by collecting the sub-response 130 generated for each of the target sections. At this stage, the generated response 140 may correspond to a final response to the IR 110. The process of generating the sub-response 130 will be described in more detail with reference to FIG. 2B below, and the process of generating the response 140 will be described in more detail with reference to FIG. 2C below.

The neural network model 100 may be, for example, an encoder-only model and/or a large language model (LLM), but is not necessarily limited thereto.

The neural network model 100 may include a transformer and may perform such as a self-attention mechanism, multi-head attention, and/or positional encoding.

The self-attention mechanism may dynamically evaluate and allocate a higher weight to an important word, enabling the neural network model 100 to effectively integrate contextual information and understand the overall structure of a sentence.

The multi-head attention may allow the neural network model 100 to capture diverse contextual representations by being trained with various segments of input data independently using a plurality of attention heads simultaneously. The positional encoding may directly encode order information (positional information) of words and add the positional information of each word to a vector to allow the neural network model 100 to recognize the word order within the input data.

For example, it is assumed that the IR 110 includes a request such as, “It is necessary to confirm whether a small-scale model is being used in virus clearance studies. If not, please provide a material to verify effectiveness of a model used in virus clearance studies.” In this case, the electronic device may identify a model presented in the CTD for the virus clearance studies, list up materials for the effectiveness of the model, retrieve relevant material, and generate a response based on a retrieval result.

Alternatively, it is assumed that the IR 110 includes a request such as, “The method of storing a manufactured drug is described as storing at room temperature for 1 month and then storing at 3 degrees for 34 months. Provide stability data to describe clinical justification.” In this case, the electronic device may check an experiment for the drug storage method and, proceed with a new experiment if necessary or retrieve existing material data to generate a response.

As described above, the electronic device according to one or more embodiments may automatically analyze a request of the IR 110 using the neural network model 100 and the plurality of AI agents to generate and provide the response 140 that satisfies the request, thereby improving the efficiency of an approval task of writing and submitting a response, which is a repeated and labor-intensive task in the drug approval process.

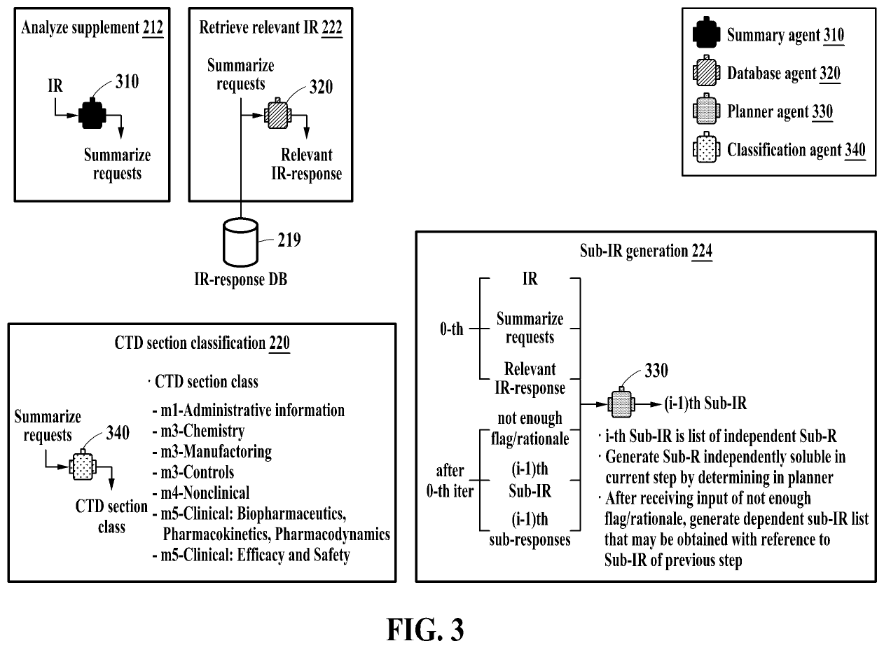

FIG. 2A illustrates an example process by which an electronic device generates a sub-IR using a neural network model according to one or more embodiments, and FIG. 3 illustrates an example operation of AI agents that collaborate to generate a sub-IR according to one or more embodiments. Referring to FIGS. 2A and 3, the electronic device may generate a sub-IR 120 via operations 210 through 226 executed by a sub-IR generation agent 201. The sub-IR generation agent 201 may include various individual agents such as a summary agent 310, a Database (DB) agent 320, a planner agent 330, and a classification agent 340.

In operation 210, the electronic device may receive an IR. The received IR may be transferred to operation 212 and operation 224 and may also be transferred to operation 250 of FIG. 2C via path \textcircled{A}.

In operation 212, the electronic device may analyze the IR received in operation 210. At this stage, the electronic device may generate a request summary that summarizes the request of the IR using the summary agent 310 that understands and summarizes the request from the approval agency. The request summary generated by the summary agent 310 may be used in a retrieval process of a relevant standard document and source document of operation 214 and a CTD section classification process of operation 220.

In operation 220, the electronic device may classify sections (“target sections”) of at least one item for which the supplement is requested through the IR based on the request summary. The sections of the at least one item may correspond to, for example, a CTD section. The electronic device may classify the CTD section class based on which section of the CTD the IR corresponds to, for example, using the classification agent 340. The classifying of the CTD section class may be performed to increase an accuracy when performing relevant supplementation retrieval through an approved document DB 219 storing information related to existing approved document in operation 222. The approved document DB 219 is a DB for the relevant supplementation retrieval and may store a previous information request and a response responding thereto. The approved document DB 219 may be constructed at a level of the sub-IR. The approved document DB 219 may store an IR-response pair storing an IR and response information responding thereto. Using the approved document DB 219, the electronic device may easily decompose a sub-IR corresponding to a new IR by dividing and processing each item of the IR into levels of the sub-IR and a sub-response corresponding thereto for each of target sections.

The CTD section class classified in operation 220 may be used to perform the relevant supplementation retrieval in operation 222 along with the request summary. In operation 222, the electronic device may perform the relevant supplementation retrieval of retrieving a similar case that is similar to a corresponding IR (or at least one item included in a corresponding IR) among a previous project and a previous supplementation response stored in the approved document DB 219. The relevant supplementation retrieval in operation 222 may correspond to a process of retrieving a relevant IR and a response from the approved document DB 219 of previously approved new drug products. In operation 222, the DB agent 320 may receive a request summary from the summary agent 310 and retrieve the relevant IR and the response from the approved document DB 219. The results of the relevant supplementation retrieval in operation 222 may be transferred to operation 230 of FIG. 2B via path \textcircled{E}.

In operation 214 in which the request summary generated by the summary agent 310 and classification classes of target sections classified in operation 220 are received, the electronic device may retrieve the relevant standard document and source document by obtaining CTD data corresponding to the target sections from a CTD DB 215 based on the request summary and the classification result of the target sections.

In operation 216, the electronic device may determine supplementation relevance by analyzing a background of a request of the IR, that is, whether the request of the IR is a simple error correction request or a request requiring an additional response, using the relevant standard document and source document retrieved in operation 214.

When it is determined that the request of the IR is a request due to a simple error (“False”) in operation 216, in operation 218, the electronic device may notify the user that the request of the IR is a simple error, and terminate the procedure.

When it is determined that the request of the IR is a request requiring an additional response (“True”) in operation 216, in operation 224, the electronic device may generate the sub-IR. In operation 224, the electronic device may perform a process of dividing an IR, which is very complex and requires specialized knowledge to write a supplementation response into independently solvable sub-IR. The electronic device may generate the independent sub-IR for each of target sections by reflecting the IR, the request summary received from the summary agent 310, the classification class (CTD section class) of the target sections received from the classification agent 340, and/or a context (e.g., a relevant IR-response) of the relevant IR and the response (R) retrieved during the relevant supplementation retrieval process by the DB agent 320 in operation 222. In operation 224, the electronic device may generate the sub-IR using the planning agent 330. At this stage, the electronic device may generate the sub-IR by reflecting information (e.g., a result of determining whether it is enough for the IR (e.g., a not enough flag and/or a rationale for determining that it is not enough)) transferred from operation 248 of FIG. 2C together via path \textcircled{B}. When the electronic device divides the IR into sub-IRs and then obtains sub-responses corresponding to the sub-IRs, the electronic device may transmit a not enough flag along with a rationale for what is needed as information indicating that the sub-responses are not suitable for solving the entire IR, so that the electronic device may refer to it when dividing the IR into the sub-IRs again

In operation 226, the electronic device may generate a list of sub-IRs generated for each of target sections in operation 224, and store the list for each target section in operation 228. The list of the sub-IRs may be transferred to operation 230 of FIG. 2B via path \textcircled{D}, and transferred to operation 248 of FIG. 2C via path \textcircled{C}.

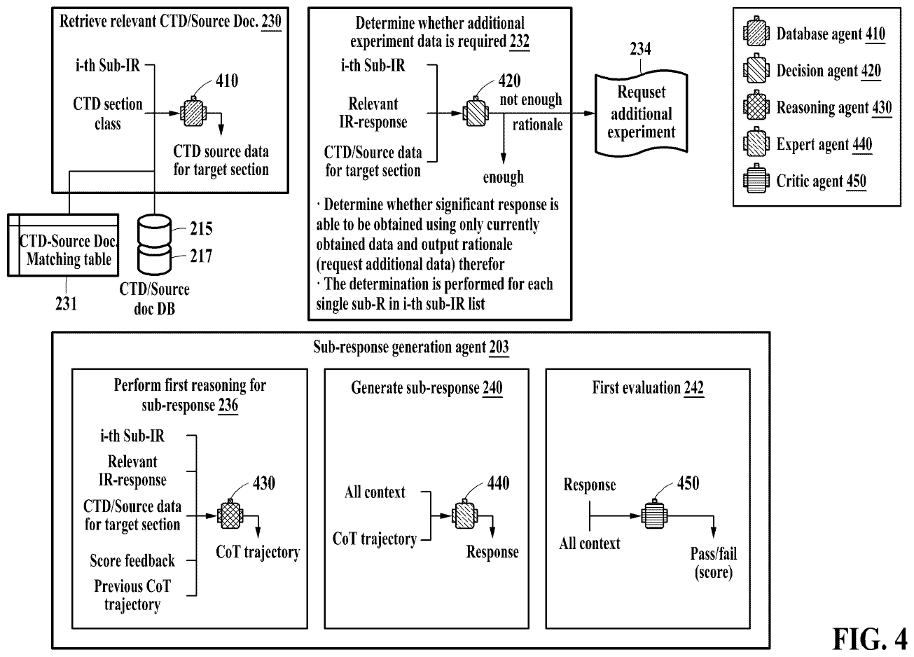

FIG. 2B illustrates an example process by which an electronic device generates a sub-response using a neural network model according to one or more embodiments, and FIG. 4 illustrates an example operation of AI agents that collaborate to generate a sub-response. Referring to FIG. 2B and FIG. 4, the electronic device may generate a sub-response 130 responding to a sub-IR for each of target sections via operations 230 through 242 using a sub-response generation agent 203. The sub-response generation agent 203 may include various individual agents such as a DB agent 410, a decision agent 420, a reasoning agent 430, an expert agent 440, and a critic agent 450.

In operation 230, the electronic device may retrieve (search) a relevant standard document (e.g., a CTD) and a source document based on the sub-IR (an i-th sub-IR) for each of target sections and the class (CTD section class) of target sections generated in operation 226 of FIG. 2A and transferred via path \textcircled{D}, and the context (Relevant IR-R context) of relevant supplementation retrieval result of operation 222 transferred via path \textcircled{E}. The electronic device may determine which CTD section the sub-IR corresponds to and may retrieve data necessary to generate a response to the sub-IR from a CTD DB 215 and a source document DB 217 using the DB agent 410.

When the sub-IR (the i-th sub-IR) and the class (the CTD section class) of the target sections are input, the DB agent 410 may search the source document DB 217 to retrieve a title of a source document that matches the class of the target sections using a matching table 231 based on the class of the target sections.

The matching table 231 may correspond to a table in which information on the CTD and information on the source document for each of target sections are matched to each other and stored. The matching table 231 may serve to organize the source documents (Source Doc) referred to write a corresponding section for each of sections of the CTD. The matching table 231 may organize source documents corresponding to the section of the CTD by mapping or linking the source documents in a format such as CTD Section 3C.2—Report 001.docx.

The DB agent 410 may retrieve a source document corresponding to the target section from the source document DB 217. The DB agent 410 may be the same as or different from the DB agent 320 of FIG. 3.

In addition, the DB agent 410 may retrieve the CTD data corresponding to the target section by searching the CTD DB 215 based on the class of the target sections.

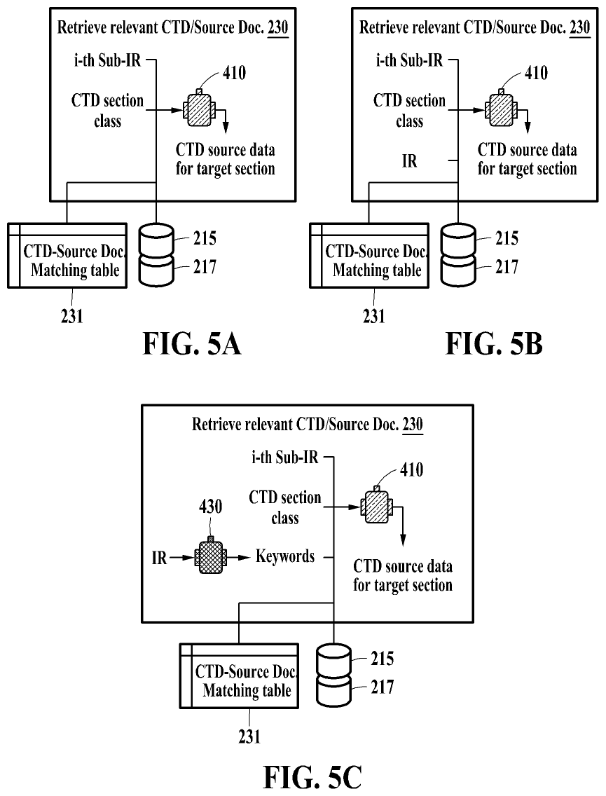

A method of retrieving (searching for) the relevant standard document (e.g., CTD) and the source document by the DB agent 410 will be described in more detail with reference to FIG. 5 below.

In operation 232, the electronic device may determine whether additional experiment data is required based on the context of the relevant standard document and the source document retrieved in operation 230. The electronic device may determine whether the additional experiment data is required for each individual sub-IR. Operation 232 may correspond to the process of determining whether a response for a sub-response is able to be generated by the source document and the standard document. In operation 232, the electronic device may extract a context matching the response requested in the sub-IR from the source document and the standard document, and determine whether the response is able to be generated based on the extracted context.

The rationale for determining whether the additional experiment data is required in operation 232 is because it may not be enough to provide the response to the sub-IR by the retrieved source document. At this stage, the electronic device may adjust the number of contexts to be extracted depending on a responding difficulty of the sub-IR. In operation 232, the electronic device may determine whether a reliable response is able to be generated, that is, whether the additional experiment data is required, based on data currently obtained by the decision agent 420.

When it is determined that the additional experiment data is required in operation 232 (“not enough”), the electronic device may request an additional experiment to obtain insufficient experiment data in operation 234 and terminate the process. At this stage, the electronic device may generate an additional experiment request signal and may transmit the additional experiment request signal together with the rationale for requesting the additional experiment.

When it is determined that the additional experiment data is not required in operation 232 (“enough”), in operation 236, the electronic device may perform a first reasoning for the sub-response. At this stage, the electronic device may plan what kind of the first reasoning is required to resolve the sub-IR using the reasoning agent 430. The reasoning agent 430 may output a Chain of Thought (CoT) trajectory by performing the first reasoning based on the sub-IR (the i-th sub-IR) for each of the target sections, the context (e.g., the relevant IR-response) of the relevant IR and the response (R) retrieved in the retrieval process of operation 230, the CTD data and the source data for each of the target sections, a first evaluation result (score feedback) fed back in operation 242, and a previous CoT trajectory. The CoT trajectory may refer to the process of reasoning through a series of logical operations to solve a complex problem.

In operation 240, the electronic device may generate a sub-response based on the context received in operation 230 and the first reasoning result of operation 236. The electronic device may generate the sub-response using the expert agent 440. The expert agent 440 may generate the sub-response, for example, based on the context of the relevant standard document and the source document retrieved in operation 230 and the first reasoning result (the CoT trajectory).

In operation 242, the electronic device may perform a self-evaluation (“first evaluation”) for the sub-response generated in operation 240. The electronic device may determine whether the response of the sub-response generated in operation 240 is enough or whether it would be better to generate the sub-response again using the critic agent 450. At this stage, the first evaluation may include a level of the response and a rationale for determining the level of the response (Rationale), and the first evaluation result may be fed back to the neural network model so that it may be used as a reference material when generating a next sub-response. The electronic device may, for example, determine a first score corresponding to the response based on a similarity between the context (All context) of the relevant standard document and the source document retrieved in operation 230 and the response of the sub-IR generated in operation 240. The electronic device may perform the first evaluation of the sub-response based on a comparison result of comparing the first score and a first threshold value.

When it is determined that the response of the sub-response is not enough based on the first evaluation result of operation 242 (“fail”), the electronic device may give feedback of at least one of the first score and the determination rationale corresponding to the first score to the first reasoning process of the neural network of operation 236 to provide it as a reference material for the first reasoning.

When it is determined that the response of the sub-response is enough by the first evaluation result of operation 242 (“pass”), in operation 244, the electronic device may transfer the sub-response (the i-th sub response) corresponding to the target section to a next process for the response generation.

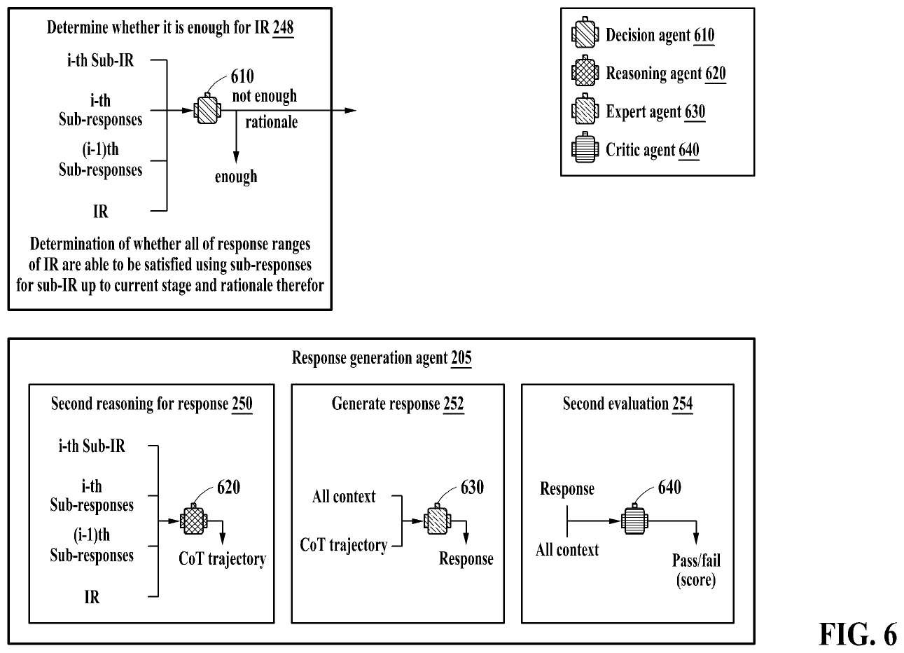

FIG. 2C illustrates an example process by which an electronic device may generate a response using a neural network model according to one or more embodiments, and FIG. 6 illustrates an example operation of AI agents that may collaborate to generate a response according to one or more embodiments. Referring to FIG. 2C and FIG. 6, the electronic device may generate a response corresponding to an IR via operations 246 through 256 using a response generation agent 205. The response generation agent 205 may include various agents such as a decision agent 610, a reasoning agent 620, an expert agent 630, and a critic agent 640.

When a sub-response corresponding to each of target sections has been generated through operation 244 of FIG. 2B, in operation 246, the electronic device may collect the sub-responses generated for each target section.

In operation 248, the electronic device may determine whether the sub-response collected in operation 246 satisfies the overall requests of the IR, that is, whether it is enough for the IR. The electronic device may determine, for example, whether the sub-IR and the sub-response are enough to resolve the supplement request of the IR using the decision agent 610. The decision agent 610 may determine whether the sub-IR and the sub-response are enough to resolve the supplement request of the IR based on the list of the sub-IRs transferred from operation 226 of FIG. 2A via path \textcircled{V} and the sub-supplementation collected in operation 246.

When it is determined that the sub-IR and the sub-response are not enough to resolve the supplement request of the IR (“not enough”), the electronic device may perform the process of generating the sub-IR in operation 224 of FIG. 2A via path \textcircled{B}. At this stage, the electronic device may transfer the rationale of determining that the sub-response is not enough to resolve the supplementation request of the IR to configure the neural network model to generate a new sub-IR with reference to the determined rationale.

When it is determined that the sub-IR and the sub-response are not enough to resolve the supplement request of the IR (“enough”) in operation 248, in operation 250, the electronic device may perform second reasoning for the response generation. The electronic device may plan what kind of reasoning is required to resolve the IR using the reasoning agent 620. The reasoning agent 620 may perform the second reasoning based on the IR transferred in operation 210 via path \textcircled{A}, the sub-supplementations collected and responses of the sub-supplementations collected in operation 246, and/or a fed-back second evaluation result (score feedback). The reasoning agent 620 may output the CoT trajectory for the second reasoning. The reasoning agent 620 may be the same as or different from the reasoning agent 430 of FIG. 4.

In operation 252, the electronic device may generate a response based on the second reasoning result (CoT trajectory) of operation 250 and the response of the sub-supplementation collected in operation 246. The response generated at this stage may correspond to the entire response responding to all of items included in the IR. The electronic device may generate the sub-response using the expert agent 630. The expert agent 630 may receive the sub-IR, the sub-response, and the CoT trajectory and generate and/or output the response. The expert agent 630 may be the same as or different from the expert agent 440 of FIG. 4.

In operation 254, the electronic device may perform the second evaluation on the response generated in operation 252. The electronic device may determine, for example, whether the response generated in operation 252 is enough or it would be better to generate the response again using the critic agent 640.

The critic agent 640 may output the level of the response as the second evaluation result (e.g., a second score), and also provide the rationale for the determination thereof to configure the neural network model to utilize it as the reference material when generating a next response. At this stage, a method of determining the second score using the critic agent 640 is similar to the method of determining the first score described above, and therefore, the relevant part may be referred to.

The critic agent 640 may be the same as or different from the critic agent 450 of FIG. 4. At this stage, the second evaluation may include a level of the response and a rationale for determining the level of the response (Rationale), and the second evaluation result may be fed back to the neural network model so that it may be used as a reference material when generating a next response. The electronic device may, for example, determine the second score corresponding to the response of the response based on the similarity between the response of the sub-supplementation collected in operation 246 and the response of the response generated in operation 252. The electronic device may perform the second evaluation of the response based on a comparison result of comparing the second score and a second threshold value.

When it is determined that the response of the response is not enough based on the second evaluation result of operation 254 (“fail”), the electronic device may give feedback of at least one of the second score and the determination rationale corresponding to the second score to the second reasoning process of the neural network of operation 250 to provide it as a reference material for the second reasoning.

When it is determined that the response of the response is enough by the second evaluation result of operation 254 (“pass”), in operation 256, the electronic device may output the response. At this stage, the response may be a document including the entire response to the items included in the IR.

FIGS. 5A through 5C illustrate respective example method of retrieving a source document and a standard document using a DB agent according to one or more embodiments.

The electronic device may, for example, classify first items of the source document for each of the target sections and extract a first feature based on meaning of the classified first items corresponding to the target sections. The electronic device may classify second items of the standard document for each of the target sections and extract a second feature based on meaning of the classified second items corresponding to the target sections. The electronic device may encode the sub-IR to a third feature. The electronic device may retrieve the source document and the standard document according to whether the first feature and the second feature match the third feature.

The electronic device may retrieve the source document and the standard document from the DBs 215 and 217 via the DB agent 410.

During the process of retrieving the relevant standard document and the source document in operation 230, if the item of the sub-IR is input as a query in a text form, the electronic device may not properly retrieve the relevant materials. This is because the sub-IR has no appropriate keywords for retrieval. In an example, the sub-IR and an original IR may be applied together as an input to the DB agent 410 so that the neural network model may understand the relevant context of the sub-IR properly. In addition, in an example, keywords related to the original IR and the sub-IR may be separately extracted and added to an input query to be used for retrieval.

For example, as shown in FIG. 5A, the electronic device may retrieve the standard document from a DB (e.g., the CTD DB 215) and retrieve the source document from a DB (e.g., the source document DB 217) using a table (e.g., the matching table 231 of FIG. 2B) that matches with the class (CTD section class) of the target sections and the sub-IR (the i-th sub-IR).

As shown in FIG. 5B, the electronic device may retrieve the standard document from a DB (e.g., the CTD DB 215) and retrieve the source document from a DB (e.g., the source document DB 217) using a table (e.g., the matching table 231 of FIG. 2B) that matches with any combination of two or more of the class (CTD section class) of the target sections, the sub-IR (the i-th sub-IR), and the IR.

The electronic device may obtain CTD source data for the target sections by providing the information retrieved as in FIG. 5A or FIG. 5B to the DB agent 410.

Alternatively, as shown in FIG. 5C, the electronic device may extract keywords that are related to the sub-IR (the i-th sub-IR) from the IR using the reasoning agent 430, and retrieve the source documents and the standard documents from a DB (e.g., the CTD DB 215 and the source document DB 217) based on the extracted keywords and the class (the CTD Section Class) of the target sections. At this stage, the electronic device may extract keywords from the IR to find the source document necessary to resolve the sub-IR among files within the class (the CTD Section Class) of the target sections (e.g., m3), and provide the extracted keywords to the DB agent 410 together with the sub-IR (the i-th sub-IR).

For example, when the IR states, “Please provide information on a storage method for pharmaceutical shipment,” the sub-IR may be, “What are the conditions for pharmaceutical shipments?” In this case, the electronic device may extract a keyword (“storage method”) from the IR and retrieve the source document from the source document DB 217 using the extracted keyword and the sub-IR.

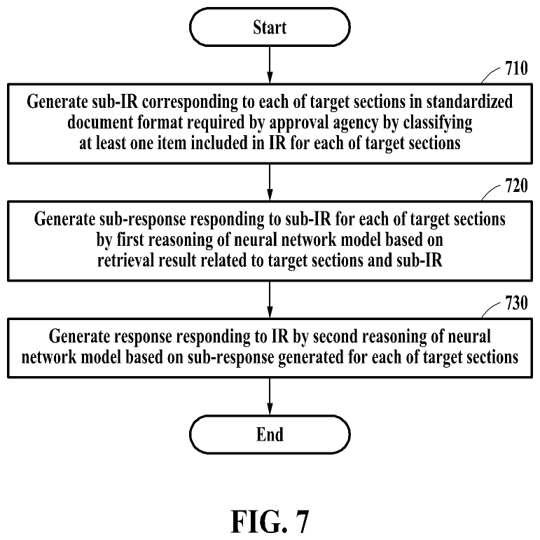

FIG. 7 illustrates an example method of automatically generating a response according to one or more embodiments. Operations to be described with reference to FIG. 7 and below may be performed sequentially but not necessarily. For example, the order of the operations may vary, and at least two of the operations may be performed in parallel or independently.

Referring to FIG. 7, an electronic device may generate a response responding to an IR by perfoming operations 710 through 730.

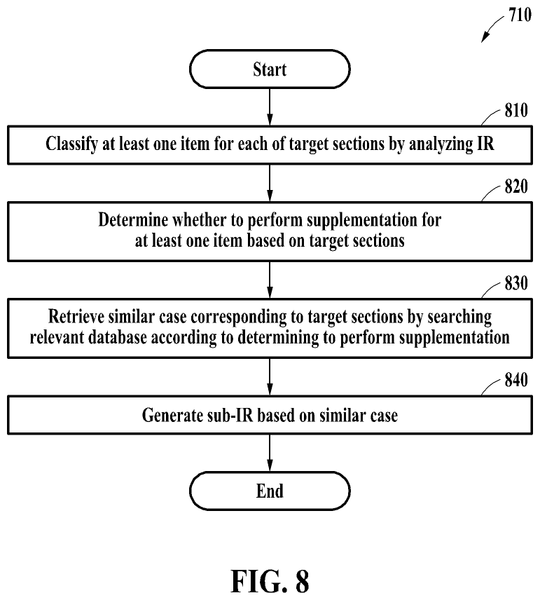

In operation 710, the electronic device may classify at least one item included in an IR for each of target sections in a standardized document format and generate a sub-IR corresponding to each of target sections. The IR may be received from a server operated by an agency responsible for new drug/generic drug approval, or an agency that verifies products such as mobile phones and home appliances. A standardized document format may be submitted to a regulatory or approval agency when developing a new drug, and may be a document that comprehensively describes safety, efficacy, and quality of new drugs. The standardized document format may be, but is not necessarily limited to, a CTD. The method of generating a sub-IR by the electronic device will be described in more detail with reference to FIG. 8 below.

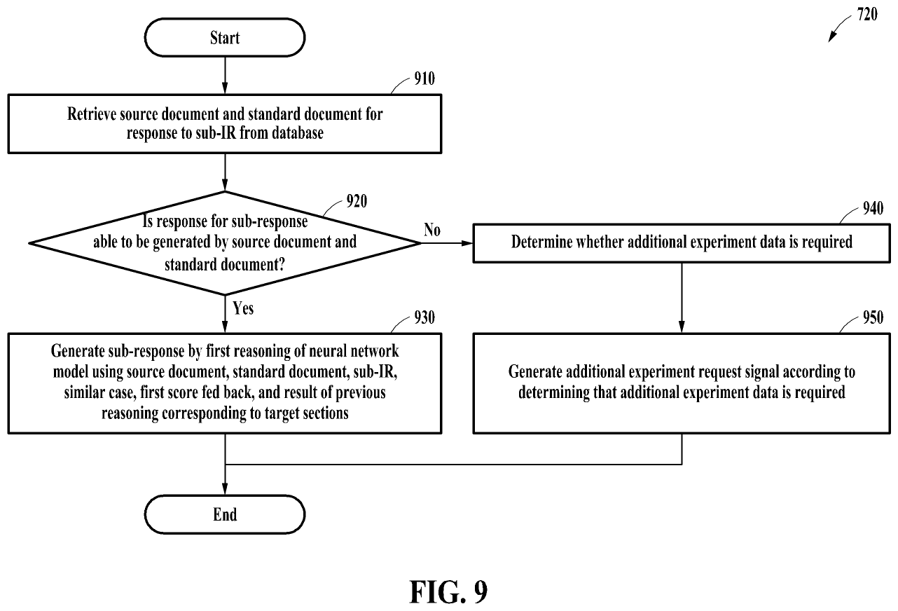

In operation 720, the electronic device may generate a sub-response responding to the sub-IR for each of the target sections by performing first reasoning of a neural network model based on a retrieval result related to the target sections and the sub-IR. The electronic device may generate a sub-response responding to each sub-IR using the content of a relevant standard document (e.g., CTD) and/or a source document. The method of generating the sub-response by the electronic device will be described in more detail with reference to FIG. 9 below.

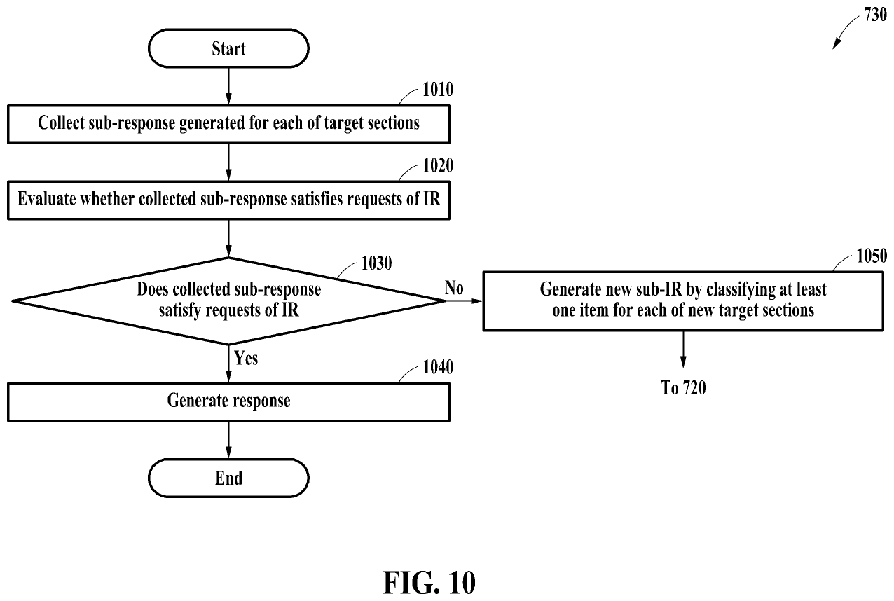

In operation 730, the electronic device may generate a response responding to the IR by performing second reasoning of the neural network model based on the sub-response generated for each of the target sections in operation 720. The method of generating the response by the electronic device will be described in more detail with reference to FIG. 10 below.

FIG. 8 illustrates an example method of generating a sub-IR according to one or more embodiments. Referring to FIG. 8, an electronic device may perform operations 810 through 840 to generate a sub-IR.

In operation 810, the electronic device may classify the at least one item for each of the target sections by analyzing the IR that includes the at least one item.

In operation 820, the electronic device may determine whether to perform supplementation for the at least one item based on the target sections classified in operation 810. The electronic device may determine whether to perform the supplementation according to whether the at least one item is a simple error or requires an additional response. The electronic device may determine whether the at least one item included in the IR is a simple error or requires an additional response by referring to a standard document (e.g., CTD) and/or a source document.

In operation 830, based on the determination in operation 820, the electronic device may retrieve a similar case corresponding to the target sections by retrieving a relevant DB. Here, the process of retrieving the similar case may include retrieving the similar IR and corresponding response in the target sections from a related DB (e.g., the approved document DB) of previously approved new drug products.

The electronic device may retrieve the similar case including a target IR and a response matching the target IR corresponding to the same section as the at least one item from the related DB storing approved documents of previously approved products by a summary (e.g., a request summary) corresponding to the at least one item. The electronic device may retrieve the similar case using a DB agent, which receives a request summary corresponding to the at least one item and retrieves the relevant IR and the response from the approved document DB. The DB agent may retrieve the similar case corresponding to the target section of the classified item in the IR among a previous project or a previous supplementation response stored in the approved document DB.

In operation 840, the electronic device may generate a sub-IR based on the similar cases retrieved in operation 830.

FIG. 9 illustrates an example method of generating a sub-response according to one or more embodiments. Referring to FIG. 9, an electronic device may perform operations 910 through 960 to generate a sub-response.

In operation 910, the electronic device may retrieve a source document and a standard document (e.g., CTD) for a response to the sub-IR from a DB. The electronic device may retrieve/search the source document and the standard document in various ways such as those described above with reference to FIG. 5.

In operation 920, the electronic device may determine whether a response for the sub-response is able to be generated using the source document and the standard document retrieved in operation 910. The electronic device may extract contextual information (e.g., contexts) matching the response requested in the sub-IR from the source document and the standard document. The electronic device may adjust the number of the extracted contexts depending on the responding difficulty of the sub-IR. The electronic device may determine whether the response is able to be generated by the extracted contexts. The electronic device may determine a first score corresponding to the response based on the similarity between the extracted contexts and the response. The electronic device may perform a first evaluation of the sub-response based on a comparison result generated by comparing the first score and a first threshold value. The electronic device may give feedback of the first score and/or the determination rationale corresponding to the first score to the neural network model to provide it as a reference material for first reasoning.

In operation 930, based on a determination that a response can be generated in operation 920, the electronic device may generate the sub-response including a response using the first reasoning of the neural network model. The process may use one or more of the source document, the standard document, the sub-IR, the similar case, a first score fed back according to previous reasoning of the neural network model, and a result of the previous reasoning corresponding to the target sections.

In operation 940, based on a determination that the response is not able to be generated in operation 920, the electronic device may evaluate and determine whether additional experiment data is required.

In operation 950, based on a determination that the additional experiment data is required in operation 940, the electronic device may generate an additional experiment request signal.

FIG. 10 illustrates an example method of generating a response according to one or more embodiments. Referring to FIG. 10, an electronic device may perform operations 1010 through 1040 to generate a response or generate a new sub-IR.

In operation 1010, the electronic device may collect the sub-response generated for each of the target sections.

In operation 1020, the electronic device may evaluate whether the sub-response collected in operation 1010 satisfies requests of the IR, that is, whether the sub-response satisfies the IR.

When it is determined that the collected sub-response satisfies the requests of the IR in operation 1030, the electronic device may generate the response (e.g., a complete response) in operation 1040.

When it is determined that the collected sub-response does not satisfy the requests of the IR in operation 1030, in operation 1050, the electronic device may generate a new sub-IR by classifying the at least one item for each of new target sections, and then perform operation 720 of FIG. 7 described above and the following operations.

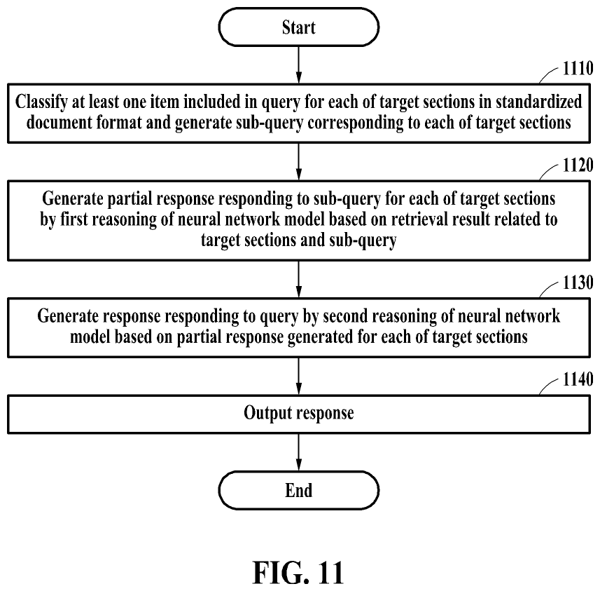

FIG. 11 illustrates an example method of automatically generating a response responding to a query according to one or more embodiments. Referring to FIG. 11, an electronic device may perform operations 1110 through 1140 to generate a response responding to a query.

In operation 1110, the electronic device may classify at least one item included in a query for each of target sections in a standardized document format and generate a sub-query corresponding to each of the target sections. The query may include various requests/tasks such as verification processes, quality assessments for various products, and/or consumer satisfaction (CS) analysis for mobile devices, home appliances, and the like, in addition to the IR described above. A sub-query is obtained by classifying the query according to predetermined classification criteria, and may correspond to the sub-IR described above and a sub-evaluation.

In operation 1120, the electronic device may generate a partial response responding to the sub-query for each of the target sections using first reasoning of a neural network model based on a retrieval result related to the target sections and the sub-query classified in operation 1110.

In operation 1130, the electronic device may generate a response (e.g., a final response) responding to the query using second reasoning of the neural network model based on the partial response generated for each of the target sections, generated in operation 1120.

In operation 1140, the electronic device may output the response generated in operation 1130. The response may be displayed via a local display of the electronic device, transmitted to another device, and/or sent over a communications network.

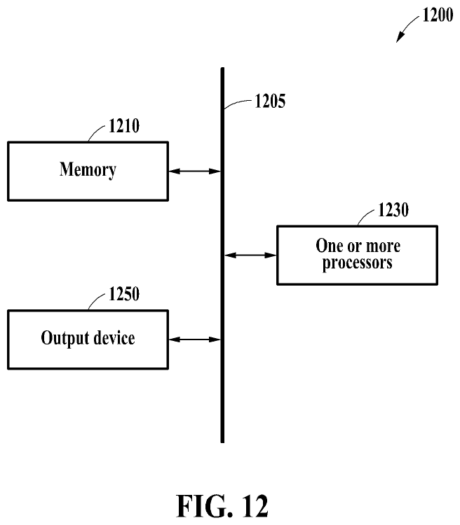

FIG. 12 illustrates an example electronic device according to one or more embodiments. Referring to FIG. 12, an electronic device 1200 may include a memory 1210 and one or more processors 1230. The electronic device 1200 may further include an output device 1250. The memory 1210, the one or more processors 1230, and the output device 1250 may be interconnected via a communication bus 1205.

The electronic device 1200 may include various types of computing hardware, such as a mobile phone, smartphone, tablet, e-book reader, laptop, personal computer (PC), workstation, and/or a server. It may also include wearable devices such as smart watches, smart eyeglasses, head-mounted displays (HMDs), and/or smart clothes, home appliances such as smart speakers, smart TVs, and/or smart refrigerators, and other smart systems such as vehicles, kiosks, Internet of things (IoT) devices, walking assist devices (WADs), drones, and/or robots.

The one or more processors 1230 may execute instructions or programs to control operations of the electronic device 1200. For example, the one or more processors 1230 may be graphics processing units (GPUs), neural processing units (NPUs), and/or tensor processing units (TPUs). In addition, in examples, the one or more processors 1230 may include a central processing unit (CPU).

The one or more processors 1230 may perform the operations described above with reference to FIGS. 1 through 11 as at least some of the instructions stored in the memory 1210 are executed by the one or more processors 1230.

The memory 1210 may store the instructions executable by the one or more processors 1230. The memory 1210 may include volatile and/or non-volatile memory.

The electronic devices, computing devices, processors, memory, storage devices, electronic device 1200, processors 1230, memory 1210, output device 1250, the communication bus 1205, and other apparatuses, devices, and components described herein with respect to FIGS. 1-14 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
classifying at least one item included in an information request (IR) for each of target sections in a standardized document format;
generating a sub-IR corresponding to each of the target sections;
for the sub-IR, generating a sub-response by performing first reasoning of a neural network model based on a retrieval result related to the target sections and the sub-IR; and
generating a final response to the IR by performing second reasoning of the neural network model based on the sub-response.

2. The method of claim 1, wherein the generating of the sub-IR comprises:
classifying the at least one item for each of the target sections by analyzing the IR;
determining whether to perform supplementation for the at least one item based on the target sections;
retrieving a similar case corresponding to the target sections by searching a relevant database (DB) in response to a determination that the supplementation is required; and
generating the sub-IR based on the similar case.

3. The method of claim 2, wherein the determining of whether to perform the supplementation comprises determining whether the at least one item is a simple error or requires an additional response.

4. The method of claim 2, wherein the retrieving of the similar case comprises retrieving, from the relevant DB storing an approved document of previously approved products, the similar case comprising a target IR corresponding to a section same as the at least one item and a response matching to the target IR by a summary corresponding to the at least one item.

5. The method of claim 1, wherein the generating of the sub-response comprises:
retrieving, from the DB, a source document and a standard document for a response to the sub-IR;
determining whether a response for the sub-response is able to be generated from the source document and the standard document; and
in response to a determination that the response is able to be generated, generating the sub-response by performing the first reasoning of the neural network model using any one or any combination of two or more of the source document, the standard document, the sub-IR, the similar case, a first score fed back according to previous reasoning of the neural network model, and a result of the previous reasoning corresponding to the target sections.

6. The method of claim 5, wherein the retrieving of the source document and the standard document comprises:
classifying first items of the source document for each of the target sections and extracting a first feature based on meaning of the classified first items corresponding to the target sections;
classifying second items of the standard document for each of the target sections and extracting a second feature based on meaning of the classified second items corresponding to the target sections;
encoding the sub-IR into a third feature; and
retrieving the source document and the standard document according to whether the first feature and the second feature match the third feature.

7. The method of claim 5, wherein the retrieving of the source document and the standard document comprises:
using a table that matches to at least two of a class of the target sections, the sub-IR, and the IR.

8. The method of claim 5, wherein the retrieving of the source document and the standard document comprises:
extracting a keyword having a correlation between the sub-IR and the IR; and
retrieving the source document and the standard document from the DB based on the keyword and a class of the target sections.

9. The method of claim 5, wherein the determining of whether the response is able to be generated comprises:
extracting one or more contexts matching to a response required by the sub-IR from the source document and the standard document; and
determining whether the response is able to be generated by the extracted one or more contexts.

10. The method of claim 9, wherein the extracting of the context comprises adjusting a number of the extracted one or more contexts based on a responding difficulty level associated with the sub-IR.

11. The method of claim 9, further comprising:
determining a first score corresponding to the response based on a similarity between the extracted one or more contexts and the response; and
performing a first evaluation of the sub-response based on a comparison result of comparing the first score and a first threshold value.

12. The method of claim 11, further comprising:
providing feedback of either one or both of the first score and a determination rationale corresponding to the first score to the neural network model, as a reference material for the first reasoning.

13. The method of claim 5, further comprising, in response to determining that the response cannot be generated:
determining whether additional experiment data is required; and
generating an additional experiment request signal when the additional experiment data is required.

14. The method of claim 1, wherein the generating of the final response comprises:
collecting the sub-response generated for each of the target sections;
determining whether the collected sub-response satisfies the IR; and
outputting the final response when the collected sub-response satisfies the IR.

15. The method of claim 14, further comprising, when the IR is not satisfied,
generating a new sub-IR by classifying the at least one item for each of new target sections.

16. An electronic device comprising:
one or more processors configured to:
classify at least one item included in an information request (IR) for each of target sections in a standardized document format and generate a sub-IR corresponding to each of target sections;
generate a sub-response to the sub-IR for each of the target sections by performing first reasoning of a neural network model based on a retrieval result related to the target sections and the sub-IR; and
generate a response to the IR by performing second reasoning of the neural network model based on the sub-response generated for each of the target sections and output the response.

17. The electronic device of claim 16, wherein the one or more processors are further configured to:
classify the at least one item for each of the target sections by analyzing the IR;
determine whether to perform supplementation for the at least one item based on the target sections;
retrieve a similar case corresponding to the target sections by searching a relevant database (DB) in response to a determination that the supplementation is required; and
generate the sub-IR based on the similar case.

18. The electronic device of claim 16, wherein the one or more processors are further configured to:
retrieve a source document and a standard document for a response to the sub-IR from the DB;
determine whether a response for the sub-response is able to be generated by the source document and the standard document; and
in response to a determination that the response is able to be generated, generate the sub-response by performing the first reasoning of the neural network model using any one or any combination of two or more of the source document, the standard document, the sub-IR, the similar case, a first score fed back according to previous reasoning of the neural network model, and a result of the previous reasoning corresponding to the target sections.

19. The electronic device of claim 16, wherein the one or more processors are further configured to:
collect the sub-response generated for each of the target sections;
determine whether the collected sub-response satisfies the IR; and
generate the response in response to a determination that the collected sub-response satisfies the IR.

20. A processor-implemented method comprising:
retrieving a similar case from a database of approved documents, the similar case comprising a prior information request (IR) and corresponding response mapped to a target section matching a classified item among target sections of a standardized document; and
generating a sub-IR for the target section based on the similar case;
retrieving, from the database, source and standard documents relevant to the sub-IR;
extracting one or more contexts from the retrieved documents, wherein a number of extracted contexts is dynamically adjusted based on a responding difficulty level of the sub-IR;
generating a sub-response via first reasoning of a neural network model using the extracted contexts;
evaluating the sub-response based on a similarity between the sub-response and the extracted contexts; and
generating a final response to an IR by aggregating sub-responses including the sub-response, and performing second reasoning of the neural network model, wherein the second reasoning incorporates feedback from the similarity to refine the final response.
